(19) United States
(12) Patent Application Publication
(10) Pub. No.: US 2017/0270433 A1
(43) Pub. Date: Sep. 21, 2017

(54) INFORMATION PROCESSING APPARATUS, INFORMATION PROCESSING SYSTEM, INFORMATION PROCESSING METHOD, AND COMPUTER-READABLE RECORDING MEDIUM

(71) Applicant: YAHOO JAPAN CORPORATION, Tokyo (JP)

(72) Inventors: Kota TSUBOUCHI, Tokyo (JP); Masaya TAJI, Tokyo (JP)

(73) Assignee: YAHOO JAPAN CORPORATION, Tokyo (JP)

(21) Appl. No.: 15/379,212

(22) Filed: Dec. 14, 2016

(30) Foreign Application Priority Data
Mar. 17, 2016 (JP) 2016-054305

(51) Int. Cl. G06N 99/00; G06N 7/00

(52) U.S. Cl. CPC G06N 99/005; G06N 7/005

(57) ABSTRACT

An information processing apparatus according to the present application includes an acquisition unit and a generation unit. The acquisition unit acquires, when a user performs one of specific behaviors respectively having a plurality of types, information on a behavior of the user performed on a terminal device and information on context associated with the user. The generation unit executes machine learning by using, as feature amounts, information on each of the specific behaviors and the information on the context, to generate a learning model of the behavior of the user performed on the terminal device.

### CROSS-REFERENCE TO RELATED APPLICATION(S)

The present application claims priority to and incorporates by reference the entire contents of Japanese Patent Application No. 2016-054305 filed in Japan on Mar. 17, 2016.

### BACKGROUND OF THE INVENTION

1. Field of the Invention

The present invention relates to an information processing apparatus, an information processing system, an information processing method, and a computer-readable recording medium.

2. Description of the Related Art

Conventionally, push-based information provision has been conducted on a user of a terminal device. The push-based information provision is expected to further increase in the future. On the other hand, there exists a fear that opportunities for the user to pay attention to each piece of notified information more decrease as the notified information more increases.

Therefore, there proposed a technology that notifies a user of information at a timing appropriate to an interruption to the user, among timings at which the behavior of the user is changed (for example, walk→stop, run→walk, etc.), on the basis of operations of the user conducted on a terminal device, so as to make the user pay attention to the provided information (for example, see non-Patent Literature 1).

Non-Patent Literature 1: T. Okoshi., “Detection of User's Interruptibility for Attention Awareness in Ubiquitous Computing”, [online], 2015. PhD Thesis, Internet <URL:https://www.ht.sfc.keio.ac.jp/toslash/papers/TadashiOk oshi_PhDThesis_20150809a.pdf>

The technology described in the aforementioned non-Patent Literature 1 can detect a timing appropriate to an interruption to a user, among timings at which the behavior of the user is changed, on the basis of operations of the user conducted on a terminal device. However, the technology desires, for example, further improvement and development.

### SUMMARY OF THE INVENTION

An information processing apparatus according to an embodiment includes an acquisition unit and a generation unit. The acquisition unit acquires, when a user performs one of specific behaviors respectively having a plurality of types, information on a behavior of the user performed on a terminal device and information on context associated with the user. The generation unit executes machine learning by using, as feature amounts, information on each of the specific behaviors and the information on the context, to generate a learning model of the behavior of the user performed on the terminal device.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an information process according to an embodiment;

FIG. 2 is a diagram illustrating a configuration example of an information processing system;

FIG. 3 is a diagram illustrating a configuration example of a terminal device;

FIG. 4 is a diagram illustrating one example of a display screen of the terminal device;

FIG. 5 is a diagram illustrating a configuration example of an information processing apparatus;

FIG. 6 is a flowchart illustrating an information processing procedure of the terminal device;

FIG. 7 is a flowchart illustrating a processing procedure of a first mode illustrated in FIG. 6;

FIG. 8 is a flowchart illustrating a processing procedure of a second mode illustrated in FIG. 6;

FIG. 9 is a flowchart illustrating a processing procedure of the information processing apparatus; and

FIG. 10 is a diagram illustrating a hardware configuration example of a computer that executes a program.

### DETAILED DESCRIPTION OF THE PREFERRED EMBODIMENTS

Hereinafter, a form (hereinafter, may be referred to as “embodiment”) for causing an information processing apparatus, an information processing system, an information processing method, and a computer-readable recording medium according to the present application to work will be described in detail with reference to accompanying drawings. The information processing apparatus, the information processing system, the information processing method, and the computer-readable recording medium according to the present application are not limited to this embodiment.

1. Information Process Including Learning Model Generating Process

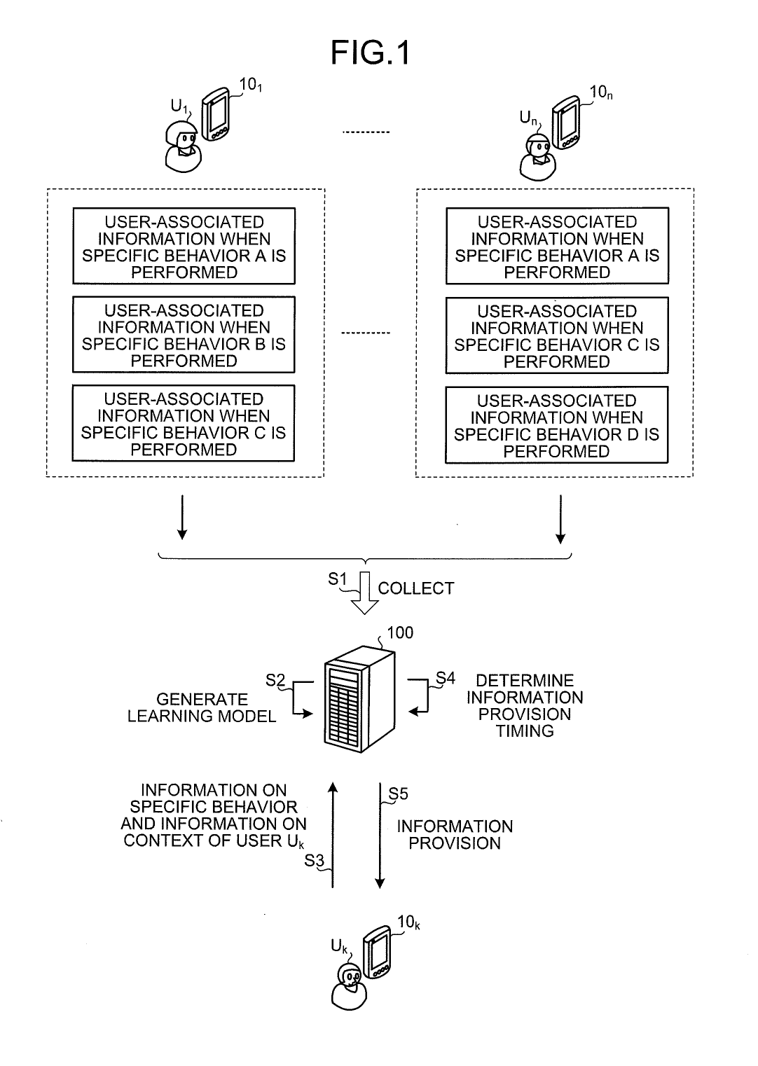

An information process including a learning model generating process according to the embodiment will be explained. FIG. 1 is a diagram illustrating an information process according to the embodiment. In an example illustrated in FIG. 1, an information processing apparatus 100 executes the information process.

The information processing apparatus 100 collects information (hereinafter, may be referred to as “user-associated information”) on a plurality of users U₁ to Uₙ (hereinafter, may be collectively referred to as “users U”) that have a plurality of terminal devices 10₁ to 10ₙ (hereinafter, may be collectively referred to as “terminal devices 10”), respectively (Step S1).

The user-associated information is information on behaviors performed on the terminal devices 10 of the plurality of users U in a case where the users U perform behaviors among specific behaviors having various types, and further is information on contexts of the users U. In the example illustrated in FIG. 1, user-associated information in a case where the user U₁ performs specific behaviors A, B, and C, user-associated information in a case where the user Uₙ performs specific behaviors A, C, and D, and the like are collected.

The aforementioned specific behavior is a behavior of the user U, which is preliminary selected as a candidate (hereinafter, may be referred to as “breakpoint”) of a timing to perform an interruption to the user U. The specific behavior is a behavior, for example, a behavior of stopping of the user U from a walking state, a behavior of walking of the user U from a running state, a behavior of standing of the user U from a sitting state, etc.

The aforementioned specific behavior considers the last behavior, however, the specific behavior may not consider the last behavior. For example, the behaviors may include a behavior of the user U of transmitting an e-mail, a behavior of the user U of operating (ON/OFF) an electrical device, a behavior of the user U of looking at a watch, etc.

The behaviors of the user U performed on the terminal device 10 (hereinafter, may be referred to as “counter terminal behaviors”) include, for example, a behaviors of the user U of responding to a content provided to the terminal device 10 from the information processing apparatus 100, a behavior of the user U of having the terminal device 10, etc.

A context associated with the user U (hereinafter, may be simply referred to as “context”) is, for example, a situation that surrounds the user U. The contexts includes details of a content to be provided to the user U, details of a content responded by the user U, an attribute of the user U, the current position of the user U, the current time, a physical environment in which the user U is put, a social environment in which the user U is put, a motion state of the user U, the emotion of the user U, etc.

When collecting a plurality of pieces of user-associated information of the users U from the plurality of terminal devices 10, the information processing apparatus 100 generates a learning model on the basis of these pieces of user-associated information (Step S2). Specifically, the information processing apparatus 100 executes machine learning by using the specific behavior and the context as the feature amount to generate a learning model of a behavior of the user U performed on the terminal device 10.

By employing the learning model, a more appropriate interruption timing (hereinafter, may be referred to as “information provision timing”) to the user in consideration of contexts of the user U can be determined among the aforementioned plurality of breakpoints.

For example, in a case where the user Uₖ of the terminal device 10ₖ (1≦k≦n) newly performs a specific behavior, the information processing apparatus 100 acquires information on the newly-performed specific behavior and information on context associated with the user Uₖ (Step S3).

In this case, the information processing apparatus 100 estimates the probability of a behavior of the user Uₖ performed on the terminal device 10, from a learning model, by using information on the new specific behavior of the user Uₖ and information on the context associated with the user Uₖ as input information. For example, in a case where the probability of a behavior of the user Uₖ performed on the terminal device 10ₖ is estimated to be high, the information processing apparatus 100 determines that it is an information provision timing.

Thus, the information processing apparatus 100 can determine whether or not it is an information provision timing to the user Uₖ that newly performed a specific behavior, on the basis of the new specific behavior of the user Uₖ and the context associated with the user Uₖ (Step S4). The information provision timing is a timing that is selected among the aforementioned plurality of breakpoints, and may be referred to as a golden breakpoint.

When determining that it is an information provision timing, the information processing apparatus 100 executes information provision that provides a content to the terminal device 10ₖ of the user Uₖ (Step S5). This content is, for example, an article of news and the like, new arrival notification of information on application, an e-mail, an advertisement content such as a coupon or a store introduction, etc. Thereby, a push-based information provision can be executed on the terminal device 10ₖ of the user Uₖ at an appropriate timing in which the probability that the user Uₖ pays attention to the provided information is high.

Moreover, the information processing apparatus 100 can transmit information on the learning model to the terminal device 10. In this case, in a case where the user U newly performs a specific behavior, the terminal device 10 can estimate the probability of a behavior of the user U performed on the terminal device 10, from the learning model, by using information on this specific behavior and information on context associated with the user U as an input information, and thus can execute information provision to the user U on the basis of the estimated result.

2. Information Processing System

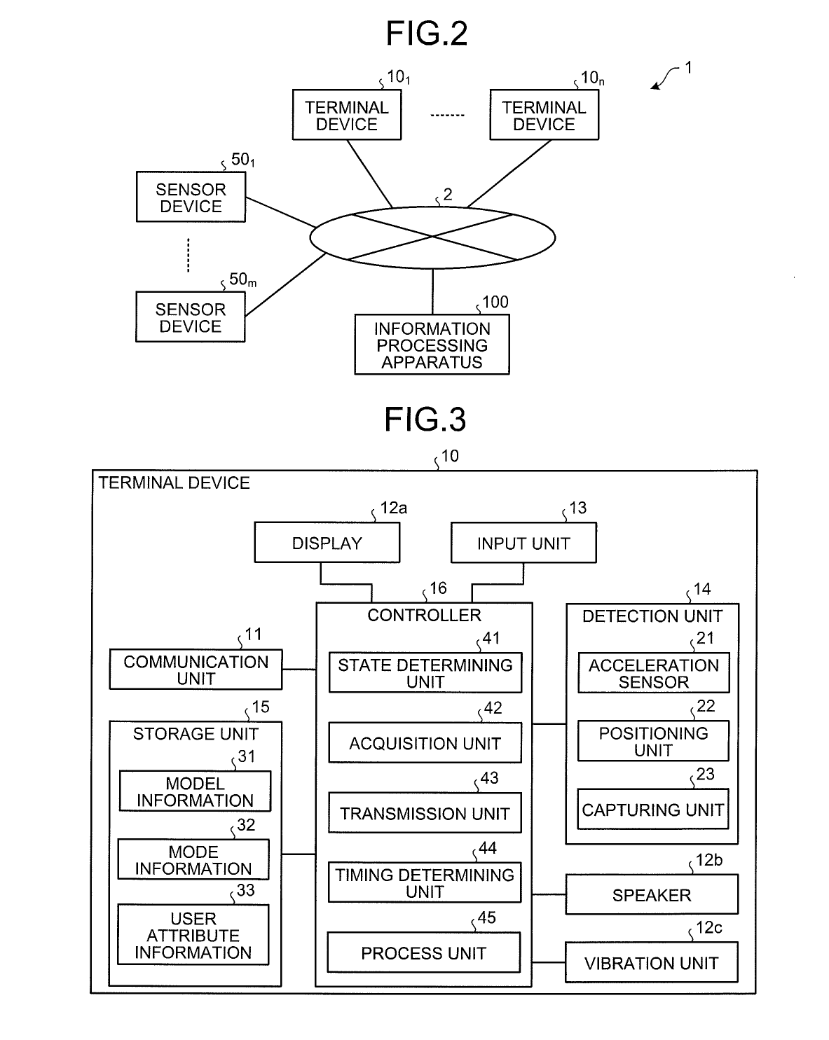

FIG. 2 is a diagram illustrating a configuration example of an information processing system 1. As illustrated in FIG. 2, the information processing system 1 according to the embodiment includes the plurality of terminal devices 10₁ to 10ₙ, sensor devices 50₁ to 50ₘ, and the information processing apparatus 100.

The plurality of terminal devices 10 and the information processing apparatus 100 are communicably connected with each other in a wired or wireless manner via a network 2. The network 2 includes, for example, a Local Area Network (LAN) and a Wide Area Network (WAN) such as the Internet.

The terminal device 10 is realized by a desktop personal computer, a notebook computer, a tablet terminal, a mobile phone, a Personal Digital Assistant (PDA), or the like. The terminal device 10 includes, for example, a plurality of applications including an information notification application, and acquires and displays a content to be notified of from the information processing apparatus 100.

The sensor devices 50₁ to 50ₘ (hereinafter, may be collectively referred to as “sensor devices 50”) can detect states of the users U, and can notify the terminal device 10 and the information processing apparatus 100 of the states via the network 2. The sensor device 50 can detect, for example, a specific behavior of the user U. The sensor device 50 may be, for example, a device (for example, watch or PC) taken along with the user U.

For example, the sensor device 50 can detect, as a specific behavior of the user U, an operation (for example, ON/OFF) of the user U on a predetermined electrical device (for example, coffee maker, lighting device, television set, refrigerator, etc.). The sensor device 50 can detect, as a specific behavior of the user U, for example, opening/closing a key, an operation state of a vehicle driven by the user U, etc.

For example, the sensor device 50 can capture the user U, execute user identification on the basis of this captured result, and detect a specific behavior (for example, behavior of stopping from walking state, behavior of sitting from standing state, etc.) of the user.

The information processing apparatus 100 can generate the aforementioned learning model on the basis of information to be provided to the information processing apparatus 100 from the terminal device 10 and the sensor device 50, and thus can provide a content to the user U at a timing being more appropriate to an interruption to the user U by using the learning model. Hereinafter, configurations of the terminal device 10 and the information processing apparatus 100 will be specifically explained.

2.1. Terminal Device

FIG. 3 is a diagram illustrating a configuration example of the terminal device 10. As illustrated in FIG. 3, the terminal device 10 includes a communication unit 11, a display 12a, a speaker 12b, a vibration unit 12c, an input unit 13, a detection unit 14, a storage unit 15, and a controller 16.

The communication unit 11 is connected with the network 2 in a wired or wireless manner, and executes input/output of information from/to the sensor device 50 and the information processing apparatus 100. For example, the communication unit 11 is realized by a Network Interface Card (NIC), etc. The controller 16 can input/output various kinds of information from/to the sensor device 50 and the information processing apparatus 100 via the communication unit 11 and the network 2.

The display 12a is a touch-screen display. The user U of the terminal device 10 operates a screen of the display 12a thereon by using a finger or the like, and thus an operation for the screen displayed on the display 12a can be executed. The display 12a is, for example, a small Liquid Crystal Display (LSD) or an organic ElectroLuminescence display (organic EL display).

The input unit 13 includes a keyboard including keys for inputting characters, numeric characters, and a space, an Enter key, arrow keys, etc.; a selection button; a power button; etc.

The detection unit 14 detects various kinds of information on the terminal device 10. Specifically, the detection unit 14 detects a physical state and a peripheral state of the terminal device 10. In the example illustrated in FIG. 3, the detection unit 14 includes an acceleration sensor 21, a positioning unit 22, and a capturing unit 23.

The acceleration sensor 21 is, for example, a triaxial acceleration sensor, and detects physical motions of the terminal device 10 such as a moving direction, the velocity, and the acceleration of the terminal device 10. The positioning unit 22 receives an electrical wave transmitted from a Global Positioning System satellite (GPS satellite), and acquires, on the basis of the received electrical wave, position information (for example, latitude and longitude) indicating the current position of the terminal device 10. The capturing unit 23 captures the periphery of the terminal device 10 to acquire a capture image.

The detection unit 14 may include various devices that detect physical states of the terminal device 10, not limited to the acceleration sensor 21, the positioning unit 22, and the capturing unit 23. For example, the detection unit 14 may include a microphone that collects peripheral sounds of the terminal device 10, a lighting intensity sensor that detects the peripheral lighting intensity of the terminal device 10, a humidity sensor that detects the peripheral humidity of the terminal device 10, a geomagnetic sensor that detects the magnetic field at the current position of the terminal device 10, etc.

The storage unit 15 stores information including model information 31, mode information 32, user attribute information 33, etc. The storage unit 15 is, for example, a semiconductor memory element such as a Random Access Memory (RAM) or a flash memory; or a storage device such as a Hard Disk Drive (HDD) or an optical disk.

The model information 31 is information on a model that estimates the probability of a behavior of the user U performed on the terminal device 10, and includes, for example, information on a learning model and an estimation model, which are generated by the information processing apparatus 100. The mode information 32 is information on an operation mode that is set by the user U of the terminal device 10. The user attribute information 33 is information on, for example, attributes (for example, age, gender, address, occupation, interest and attention, etc.) of the user U.

The controller 16 includes, for example, a microcomputer including a Central Processing Unit (CPU), a Read Only Memory (ROM), a Random Access Memory (RAM), an input/output port, and the like; and various circuits.

The controller 16 includes a state determining unit 41, an acquisition unit 42, a transmission unit 43, a timing determining unit 44, and a process unit 45. For example, the aforementioned CPU reads out and executes a program stored in the aforementioned ROM to realize functions of the state determining unit 41, the acquisition unit 42, the transmission unit 43, the timing determining unit 44, and the process unit 45.

A part or whole of each of the state determining unit 41, the acquisition unit 42, the transmission unit 43, the timing determining unit 44, and the process unit 45 may be constituted of hardware of an Application Specific Integrated Circuit (ASIC), a Field Programmable Gate Array (FPGA), etc. Hereinafter, the state determining unit 41, the acquisition unit 42, the transmission unit 43, the timing determining unit 44, and the process unit 45 will be specifically explained.

2.1.1. State Determining Unit

The state determining unit 41 determines a state of the user U. For example, the state determining unit 41 determines whether or not a behavior of the user U is a specific behavior on the basis of a physical motion of the terminal device 10 detected by the acceleration sensor 21. The state determining unit 41 can determine whether or not a behavior of the user U is a specific behavior on the basis of position information that indicates the current position of the terminal device 10 detected by the positioning unit 22.

As described above, the specific behaviors include, for example, a behavior of stopping of the user U from a walking state, a behavior of walking of the user U from a running state, a behavior of standing from a sitting state, a behavior of sitting from a standing state, etc.

The state determining unit 41 can determine, as specific behaviors, for example, a behavior of the user U of watching television, a behavior of the user U of looking at a watch, a behavior of the user U of drinking coffee, etc. from images captured by the capturing unit 23.

The state determining unit 41 can detect a state of the user U on the basis of, for example, information detected by the sensor device 50. For example, the sensor device 50 can detect an operation of the electrical device, and, on the basis of the detection result, the state determining unit 41 can determine that the user U operates the electrical device.

The state determining unit 41 can detect an operation of the terminal device 10 performed by the user U. The storage unit 15 stores, as log information, an operation history of an application operated in the terminal device 10 caused by the user U, and thus, on the basis of the log information, the state determining unit 41 can detect, as a specific behavior, the use of the application of the terminal device 10 by the user U. For example, the state determining unit 41 can detect, as a specific behavior, transmission of an e-mail from the terminal device 10 caused by the user U on the basis of the log information stored in the storage unit 15.

The state determining unit 41 can determine whether or not the user U holds the terminal device 10 on the basis of a physical motion of the terminal device 10 detected by the acceleration sensor 21. The state determining unit 41 can determine a motion state of the user U on the basis of a physical motion of the terminal device 10 detected by the acceleration sensor 21.

The state determining unit 41 can determine the emotion of the user U on the basis of a face image the user U captured by the capturing unit 23 of the detection unit 14 or sounds of the user U collected by the microphone of the detection unit 14. The state determining unit 41 can also determine the emotion of the user U on the basis of information from a heartbeat detecting unit (not illustrated).

2.1.2. Acquisition Unit

The acquisition unit 42 can acquire a content from the information processing apparatus 100 via the communication unit 11. For example, the acquisition unit 42 can acquire a content transmitted from the information processing apparatus 100 by using a push-based information provision. The acquisition unit 42 can acquire a content to be displayed on the display 12a from the information processing apparatus 100 on the basis of the determination result determined by the timing determining unit 44 to be mentioned later, and can store the content in the storage unit 15.

The acquisition unit 42 can acquire, as user-associated information, information including information on a counter terminal behavior that is a behavior of the user U performed on the terminal device 10 and information on context associated with the user U in a case where the state determining unit 41 determines that the behavior of the user U is the specific behavior.

The acquisition unit 42 can acquire, as a counter terminal behavior, for example, information that indicates whether or not operation is executed for a content, which is provided from the information processing apparatus 100 to be displayed on the display 12a, from a touch panel of the display 12a or the input unit 13.

The acquisition unit 42 can acquire, as information on context associated with the user U, information on, for example, the current position of the user U, the current time, an attribute of the user U, details of a content to which the user U responds, a motion state of the user U, the emotion of the user U, etc.

For example, the acquisition unit 42 can acquire, as information on the current position of the user U, position information that indicates the current position of the terminal device 10 detected by the positioning unit 22. The acquisition unit 42 can acquire information on the current time (for example, year, month, day, hour, and minute) counted by a timepiece unit (not illustrated) of the controller 16. The acquisition unit 42 can acquire, as information on an attribute of the user U, the user attribute information 33 from the storage unit 15.

The acquisition unit 42 can acquire information on a motion state of the user U, the emotion of the user U, etc., which are determined by the state determining unit 41, from the state determining unit 41. Moreover, the acquisition unit 42 can also acquire information that indicates a physical environment in which the user U is put and a social environment in which the user U is put from an external device (not illustrated).

As described above, the storage unit 15 stores log information, and the acquisition unit 42 can acquire information on details of a content to which the user U responds on the basis of the log information.

The acquisition unit 42 can acquire information on a learning model and information on an estimation model from the information processing apparatus 100, and can store the acquired information on a learning model and information on an estimation model in the storage unit 15 as the model information 31.

2.1.3. Transmission Unit

The transmission unit 43 can transmit information acquired by the acquisition unit 42 as user-associated information to the information processing apparatus 100 via the communication unit 11. The user-associated information includes, for example, information that indicates a type of a specific behavior of the user U determined by the state determining unit 41, and information on a counter terminal behavior of the user U and information on context associated with the user U in a case where a behavior of the user U is a specific behavior.

In a case where the storage unit 15 stores information on a first mode as the mode information 32, the transmission unit 43 can transmit, as first user-associated information, the user-associated information acquired by the acquisition unit 42 to the information processing apparatus 100 via the communication unit 11. In a case where the storage unit 15 stores information on a second mode as the mode information 32, the transmission unit 43 can transmit, as second user-associated information, the user-associated information acquired by the acquisition unit 42 to the information processing apparatus 100 via the communication unit 11.

The transmission unit 43 can notify the information processing apparatus 100 of, for example, information on a type or details of another content that is notified of from a device other than the information processing apparatus 100 to the terminal device 10. The transmission unit 43 can transmit, to the information processing apparatus 100, the user attribute information 33 stored in the storage unit 15 and information on a behavior of the user U performed on the terminal device 10 (for example, behavior of user U for content displayed on terminal device 10).

2.1.4. Timing Determining Unit

In a case where the storage unit 15 stores information on the second mode as the mode information 32, similarly to a process to be mentioned later executed by the information processing apparatus 100, the timing determining unit 44 can determine, from a learning model, an information provision timing that is a timing being appropriate to an interruption to the user U.

For example, the timing determining unit 44 acquires information on a learning model included in the model information 31 stored in the storage unit 15, and estimates the probability of a behavior of the user U performed on the terminal device 10, from the learning model, by using user-associated information acquired by the acquisition unit 42 as input information.

In this case, for example, the timing determining unit 44 can also determine, for the contents stored in the storage unit 15, the probability of a behavior of the user U performed on the terminal device 10 by using a learning model.

In a case where the timing determining unit 44 estimates, for the content stored in the storage unit 15, that the probability of a behavior of the user U performed on the terminal device 10 is high, the timing determining unit 44 determines that it is an information provision timing.

2.1.5. Process Unit

The process unit 45 controls, for example, the display 12a, the speaker 12b, and the vibration unit 12c. For example, in a case where the storage unit 15 stores information on the first mode as the mode information 32, the process unit 45 can provide to the user U the content acquired from the information processing apparatus 100 by using a push-based information provision. For example, the process unit 45 can control the display 12a, the speaker 12b, and the vibration unit 12c by using a notification mode according to a request of the information processing apparatus 100, and thus the process unit 45 can execute, on the user U, information provision including notification of content acquisition.

The notification modes include, for example, modes such as “notification method”, “notification content”, and “notification means”. The “notification method” is, for example, an output pattern of a content. Change targets to be changed by the “notification method” include, for example, at least one of the loudness, frequency, and sound pattern of a notification sound to be output from the speaker 12b; the largeness, color, and shape of a content to be displayed on the display 12a; the repeat count of notification; etc.

The “notification content” is, for example, the range of a content to be notified of. For example, change targets to be changed by “notification content” include a details to be notified of (for example, only title, only title and summary, entire text, etc.) in details included in a content to be notified of, the number of contents to be notified of, etc.

The “notification unit” is, for example, at least one of the display 12a, the speaker 12b, and the vibration unit 12c. The “notification unit” includes, for example, peripheral devices of the user U (for example, wristwatch, refrigerator, television set, etc.). The process unit 45 can transmit a content to the peripheral device of the user U via the communication unit 11, thereby, information provision can be executed on the user U from the peripheral device of the user U.

In a case where the timing determining unit 44 determines that it is an information provision timing, the process unit 45 can display a content stored in the storage unit 15 on the display 12a.

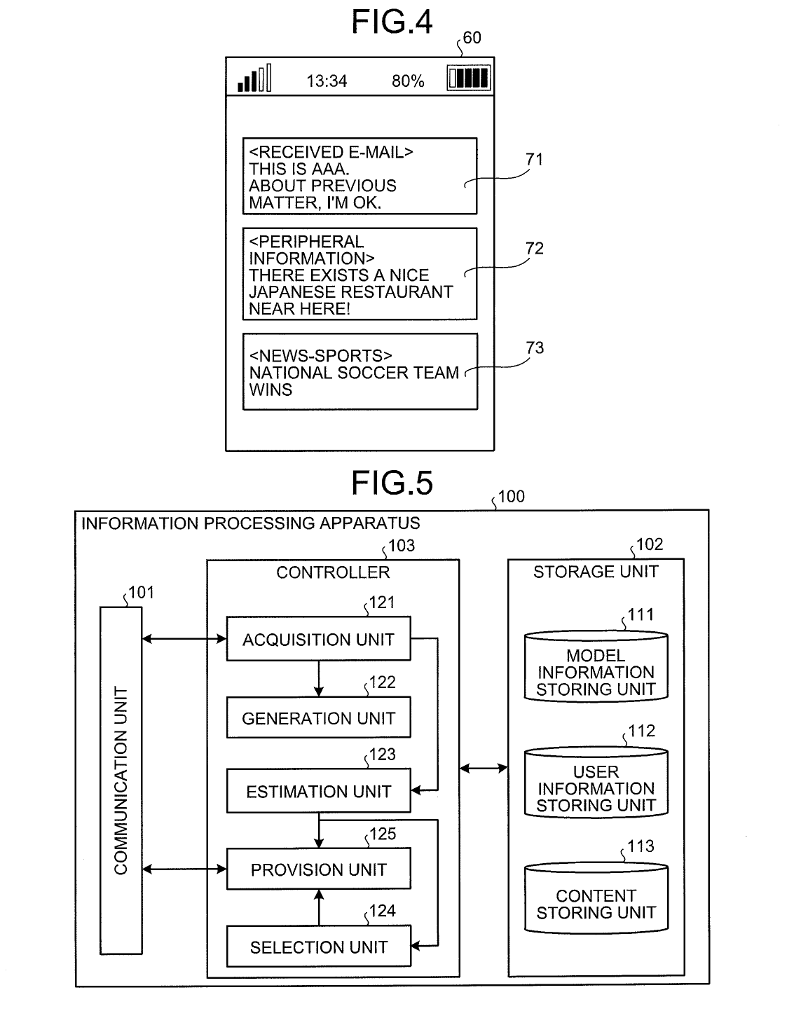

FIG. 4 is a diagram illustrating one example of a display screen of the terminal device 10. On a display screen 60 illustrated on FIG. 4, contents 71 to 73 are displayed, which are provided from an external device such as the information processing apparatus 100. The contents 71 to 73 are displayed on the display screen 60, for example, at details within the range according to the aforementioned “notification content”. In a case where the user U selects (clicks) the content displayed on the display screen 60, the process unit 45 displays the whole of the details of the selected content on the display 12a. Thereby, the user U can understand the whole of the content.

The content 71 is a content that indicates the details of a received e-mail, and, in a case where the user U selects (clicks) the content 71, the display 12a displays a mail screen caused by a mail application of the terminal device 10.

The content 72 is information on the periphery of the terminal device 10, and, in a case where the user U selects (clicks) the content 72, the display 12a displays a screen that indicates specific information on the periphery of the terminal device 10 caused by an information notification application of the terminal device 10. This content 72 is, for example, a content to be provided from a device of another administrator other than an administrator of the information processing apparatus 100.

The content 73 is information on news, and, in a case where the user U selects (clicks) the content 73, the display 12a displays a screen that indicates specific article details of news caused by an information notification application of the terminal device 10.

In a case where the timing determining unit 44 determines that it is an information provision timing, the process unit 45 can provide, to the user U, a content according to information on a type or details of another content (for example, content 71) displayed on the display 12a among the contents stored in the storage unit 15.

For example, the process unit 45 can provide, to the user U, a content that does not compete with another content, and further can provide, to the user U, a content whose interest degree of the user U is higher than another content. The interest degree of the user U is determined by the process unit 45 on the basis of, for example, the user attribute information 33 stored in the storage unit 15.

The process unit 45 can display a content in the notification mode according to the estimated result of the timing determining unit 44. For example, the process unit 45 can change at least one of a notification method, notification details, and notification means of a content in accordance with a type of a counter terminal behavior whose probability is estimated to be high by the learning model. A process of deciding a notification mode is a process that is similar to a process to be mentioned later executed by the information processing apparatus 100, and thus the explanation thereof is omitted here.

2.2. Information Processing Apparatus

FIG. 5 is a diagram illustrating a configuration example of the information processing apparatus 100. As illustrated in FIG. 5, the information processing apparatus 100 includes a communication unit 101, a storage unit 102, and a controller 103.

The communication unit 101 is connected with the network 2 in a wired or wireless manner, and executes input/output of information from/to the terminal device 10 and the sensor device 50. For example, the communication unit 101 is realized by a Network Interface Card (NIC), etc. The controller 103 can execute input/output of various kinds of information from/to the terminal device 10 and the sensor device 50 via the communication unit 101 and the network 2.

The storage unit 102 includes a model information storing unit 111, a user information storing unit 112, and a content storing unit 113. Each of the model information storing unit 111, the user information storing unit 112, and the content storing unit 113 is, for example, a semiconductor memory element such as a RAM or a flash memory; or a storage device such as a HDD or an optical disk.

The model information storing unit 111 stores a learning model that estimates the probability of a behavior of the user U performed on the terminal device 10 and information on an estimation model that estimates the length of a specific behavior. The user information storing unit 112 can store information on the user U that includes, for example, information on attributes (for example, age, gender, address, occupation, interest and attention, etc.) of the user U and the like. The content storing unit 113 stores information on a content to be provided to the terminal device 10 of the user U.

The controller 103 includes a microcomputer that includes, for example, a CPU, a ROM, a RAM, an input/output port, and the like; and various circuits. The controller 103 includes an acquisition unit 121, a generation unit 122, an estimation unit 123, a selection unit 124, and a provision unit 125. For example, the aforementioned CPU reads out and executes a program memorized in the aforementioned ROM, and thereby, functions of each of the acquisition unit 121, the generation unit 122, the estimation unit 123, the provision unit 125, and the selection unit 124 are realized.

A part or whole of each of the acquisition unit 121, the generation unit 122, the estimation unit 123, the selection unit 124, and the provision unit 125 may be constitute of hardware of an ASIC, a FPGA, or the like. Hereinafter, the acquisition unit 121, the generation unit 122, the estimation unit 123, the selection unit 124, and the provision unit 125 will be specifically explained.

2.2.1. Acquisition Unit

The acquisition unit 121 can acquire information (for example, first user-associated information and second user-associated information) to be transmitted from the terminal device 10 via the communication unit 101.

The acquisition unit 121 can store, in the user information storing unit 112, user-associated information acquired from the terminal device 10 and detection information acquired from the sensor device 50. The acquisition unit 121 can store, in the user information storing unit 112, the user attribute information acquired from the terminal device 10.

The sensor device 50 can transmit the detected information, not to the terminal device 10, but to the information processing apparatus 100. In this case, the acquisition unit 121 can acquire information detected by the sensor device 50 via the communication unit 101 from the sensor device 50.

The acquisition unit 121 can acquire information on context associated with the user U from the user information storing unit 112 and an external device. For example, the acquisition unit 121 can acquire, from the user information storing unit 112, information on an attribute of the user U and information on details of a content to which the user U responds.

The acquisition unit 121 can acquire, from an external device, information on a social environment (for example, degree of economy, commodity and service in fashion, etc.) in which the user U is put on the basis of information on the current position of the user U included in the user-associated information. The acquisition unit 121 can acquire, from an external device, information on a physical environment (temperature, weather, etc.) in which the user U is put on the basis of information on the current position of the user U included in the user-associated information.

2.2.2. Generation Unit

The generation unit 122 executes, on the basis of the user-associated information stored in the storage unit 102, machine learning by using each specific behavior of the user U and context of the user U as the feature amount, and generates a learning model of a behavior of the user U performed on the terminal device 10. The generation unit 122 stores information on the generated learning model in the model information storing unit 111.

The generation unit 122 determines, as a learning model, a regression model in which, for example, right or wrong of a behavior (counter terminal behavior) of the user U performed on the terminal device 10 is a target variable (correct answer data) and a combination of right or wrong of each specific behavior of the user U and details of context of the user U is an explanation variable (feature). For example, the generation unit 122 determines the regression model indicated by, for example, the following formula (1).

y=a₁₁·(x₁,z₁)+a₁₂·(x₁,z₁)+ . . . +aₙₘ·(xₙ,aₘ) (1)

In the aforementioned formula (1), “x₁” to “xₙ” are information on respective specific behaviors of the user U, and “z₁” to “zₘ” are information on details of respective contexts of the user U. The (x₁,z₁) means that a combination of the specific behavior “x₁” and details of context “z₁” is an explanation variable (feature), and, in a case where both “x₁” and “z₁” are “1”, (x₁,z₁)=“1”.

Herein, “y” is right or wrong of a counter terminal behavior of the user U. In a case where a counter terminal behavior of the user U exists, “y”=“1”. In a case where a counter terminal behavior of the user U does not exist, “y”=“−1”. The generation unit 122 can generate a learning model for each type of a counter terminal behavior. For example, in a case where types of counter terminal behaviors of the user U are a first type to the n-th type, the generation unit 122 can generate a learning model by using right or wrong of the counter terminal behaviors of the first to n-th types as “y₁” to “yₙ”.

For example, “y₁” indicates whether or not the user U responds to a content provided from the information processing apparatus 100. In a case where the user U responds to the content, “y₁”=“1”. In a case where the user U does not respond to the content, “y₁”=“−1”. Herein, “y₂” indicates whether or not the user U has the terminal device 10. In a case where the user U has the terminal device 10, “y₂”=“1”. In a case where the user U does not have the terminal device 10, “y₂”=“−1”.

Moreover, “x₁” indicates, for example, a behavior of stopping of the user U from a walking state, “x₂” indicates, for example, a behavior of sitting from a standing state, and “xₙ” indicates, for example, an action of operating a coffee maker.

In a case where a type of context to be used in the learning among contexts associated with the user U is details (automobile-associated, trip-associated, gourmet-associated, etc.) of a content to which the user U responds, “z₁” is, for example, “automobile”, “z₂” is, for example, “trip”, and “zₙ” is, for example, “gourmet”. Thereby, a learning model of a behavior of the user U performed on the terminal device 10 can be generated in consideration of details of the content to which the user U responds. The generation unit 122 can acquire, from the user information storing unit 112, details of the content to which the user U responds.

In a case where a type of context to be used in the learning is the current time, “z₁” is, for example, “6:00 to 6:59”, “z₂” is, for example, “7:00 to 7:59”, and “zₘ” is, for example, “5:00 to 5:59”. Herein, “z₁” may be, for example, “weekday 6:00 to 6:59”, and “z₂” may be, for example, “weekend 6:00 to 6:59”. Thereby, a learning model of a behavior of the user U performed on the terminal device 10 can be generated in consideration of the current time.

In a case where a type of context to be used in the learning is the current position of the user U, for example, prefectures and municipalities may be “z₁” to “zₘ”, and “home”, “workplace”, “in train”, “in taxi”, “business trip destination”, . . . , and the like may be “z₁” to “zₙ”. Thereby, a learning model of a behavior of the user U performed on the terminal device 10 can be generated in consideration of the current position of the user U.

In a case where a type of context to be used in the learning is a physical environment (temperature, weather, etc.) where the user U is put, combinations of temperature and weather may be “z₁” to “zₘ”. For example, “z₁” may be “10 degrees Celsius and fine”, and “z₂” may be “10 degrees Celsius and cloudy”. Thereby, a learning model of a behavior of the user U performed on the terminal device 10 can be generated in consideration of a physical environment.

In a case where a type of context to be used in the learning is a social environment in which the user U is put, for example, various social situations of the degree of the economy, a commodity and a service in fashion, and the like may be “z₁” to “zₘ”.

In a case where a type of context to be used in the learning is an attribute of the user U, for example, at least one of the age, the gender, an address distribution, a type of interest and attention of the user U may be “z₁” to “zₘ”.

Types of contexts to be used in the learning may be, for example, motion states of the user U (for example, a running time, a walking time, a sitting time, etc.), emotions of the user U (for example, smiling state, angering state, having-trouble state, etc.), schedules of the user U (for example, details of schedule at current time, details of schedule after one hour, etc.), and the like.

In the aforementioned example, the case in which the number of the types of contexts to be used in the learning is one has been explained, a plurality of types of contexts to be used in the learning may be considered. In this case, may be added to “x₁” to “xₙ” being information on the specific behaviors of the user U as the feature amounts, similarly to the aforementioned. A method thereby the feature amounts are added to “x₁” to “xₙ” may include, for example, Kronecker product and the like.

In the aforementioned example, a combination of right or wrong of each specific behavior of the user U and details of context of the user U an explanation variable (feature). However, an explanation variable (feature) not being the combination may be considered. For example, the generation unit 122 may determine, as a learning model, a regression model indicated by the following formula (2).

y=a₁·x₁+a₂·x₂+ . . . +aₙ·xₙ+b₁·z₁+b₂·z₂+ . . . +bₙ·zₘ+C₁₁·(x₁,z₁)+C₁₂·(x₁,z₂)+ . . . +Cₙₘ·(xₙ,zₘ) (2)

The generation unit 122 may change a score of the adequacy degree (hereinafter, may be referred to as “adequacy score”) being as information provision for each counter terminal behavior of the user U. For example, the generation unit 122 may multiply, for example, a learning model of each of the aforementioned counter terminal behaviors by a coefficient according to corresponding counter terminal behavior to compute the adequacy score so that the adequacy score is appropriate score according to the counter terminal behavior.

The generation unit 122 can generate an estimation model that estimates the length of each specific behavior. For example, the generation unit 122 can determine, as a length estimation model, a regression model in which the length of each specific behavior of the user U is a target variable (correct answer data), and a combination of right or wrong of the corresponding specific behavior of the user U and details of context of the user U is an explanation variable (feature).

In this case, the generation unit 122 can generate, as a length estimation model, a regression model in which “y” in the aforementioned formula (1) is the length (continuous time of specific behavior) of each specific behavior of the user U. The generation unit 122 stores information on the generated length estimation model in the model information storing unit 111.

As described above, the generation unit 122 can generate a learning model for each type of a counter terminal behavior, and furthermore, can generate a learning model for each type of context. The generation unit 122 can generate a learning model and can generate a length estimation model for each type of a counter terminal behavior and each type of the two or more contexts.

Generation of a learning model to be executed by the generation unit 122 is not limited to the aforementioned. It is sufficient that, for example, a learning model is generated for each type of a counter terminal behavior, or a learning model is generated for each type of context, as a result. For example, the generation unit 122 may generate a learning model by using a Support Vector Machine (SVM) or another machine learning method. The generation unit 122 may generate a learning model having a term of the square, cube, or the like of the feature amount (feature).

2.2.3. Estimation Unit

The estimation unit 123 estimates, by using information on the learning model stored in the model information storing unit 111, the probability of a behavior of the user U performed on the terminal device 10, from the learning model, by using information included in user-associated information acquired in the acquisition unit 121 as input information.

For example, the estimation unit 123 estimates the probability of each counter terminal behavior of the user U for information on a learning model of the corresponding counter terminal behavior stored in the model information storing unit 111 by using, as input information, information on a type of a specific behavior and context included in user-associated information.

In a case where, for example, a type of the specific behavior included in user-associated information is a behavior corresponding to “x₁” and details of context included in the user-associated information is “z₁”, the estimation unit 123 sets “x₁”=“1” and “z₁”=“1”. In a case where there exist a plurality of details of context as “z₁”=“z₃”, etc., the estimation unit 123 sets “z₁”=“1” and “z₃”=“1”. In a case where there exist a plurality of types of specific behaviors included in the user-associated information acquired in the acquisition unit 121 as “x₁”, “xₙ”, etc., the estimation unit 123 sets “x₁”=“1” and “xₙ”=“1”.

The estimation unit 123 can estimate the probability of each counter terminal behavior of the user U by using, as input information, details of a content to be provided from the provision unit 125. In this case, for example, the estimation unit 123 can estimate the probability of each counter terminal behavior of the user U for the aforementioned learning model in consideration of details of a content to which the user U responds by using, as input information, details of a content to be provided from the provision unit 125. Thereby, an appropriate timing according to a content to be provided from the provision unit 125 can be determined.

The estimation unit 123 estimates the probability of a counter terminal behavior of the user U by using, as input information, each of the details of a plurality of contents, for example, so that it is possible to determine a content whose probability of a counter terminal behavior is high (or content whose adequacy score is equal to or more than predetermined value) or a content whose probability of a counter terminal behavior is the highest (or content whose adequacy score is equal to or more than predetermined value and highest). Thereby, adequate content can be provided to the user U at an appropriate timing.

Each time acquiring user-associated information from the terminal device 10, the estimation unit 123 can estimate the probability of a counter terminal behavior (for example, aforementioned counter terminal behaviors having first to n-th types) of the user U from this user-associated information. In a case where “y” that is the computed result of the aforementioned formula (1) is equal to or more than a predetermined value (or adequacy score is equal to or more than predetermined value), the estimation unit 123 can determine that the probability of the counter terminal behavior of the user U is high. The estimation unit 123 may be configured, for example, so that the probability of one type counter terminal behavior is estimated for one user U.

Moreover, the estimation unit 123 can estimate the length of a specific behavior of the user U by using a length estimation model whose information is stored in the model information storing unit 111. For example, similarly to the case of the learning model, the estimation unit 123 can estimate the length of a specific behavior of the user U by using a length estimation model whose information is stored in the model information storing unit 111 by using, as input information, information on a type and context of the specific behavior included in the user-associated information.

2.2.4. Selection Unit

The selection unit 124 can select a content whose type is according to the length of a specific behavior estimated by the estimation unit 123.

For example, in a case where the estimation unit 123 estimates that a specific behavior of the user U is short, the selection unit 124 can select a content (for example, mail notification) that can be checked in a short time. On the other hand, in a case where the estimation unit 123 estimates a specific behavior of the user U is long, the provision unit 125 can select a content (for example, article content) that needs a long time to be checked.

The selection unit 124 can select a content having a type of a specific behavior estimated by the estimation unit 123 and whose type is according to the length of the specific behavior. Thereby, a content according to a type (for example, aforementioned “y₁” to “yₙ”) of a specific behavior, in addition to the length of the specific behavior, can be selected. In other words, for example, even when the length of a specific action whose type is standing from a sitting state is the same as the length of an specific action whose type is sitting from a standing state, different contents can be selected.

The selection unit 124 can select, for example, a content whose type is according to the length of a specific behavior estimated in the estimation unit 123 and a temporal feature of this specific behavior. Thereby, a content whose type is according to a temporal feature of the specific behavior, in addition to the length of the specific behavior, can be provided to the user U.

For example, there assumed to exist a specific action (hereinafter, may be referred to as “specific action G”) that is stopping from a running state and an specific action (hereinafter, may be referred to as “specific action H”) that is turning off a television set. In this case, even when the estimation unit 123 estimates that the lengths of the specific action G and the specific action H are the same one minute, change of the adequacy degree to an information provision timing (hereinafter, may be referred to as “information provision adequacy degree”) according to an elapsed time differs between the specific action G and the specific action H.

For example, in the specific action G, the probability of attenuation of the information provision adequacy degree is higher as the time elapses more (time attenuation exists). On the contrary, in the specific action H, even when the time elapses, the probability that the information provision adequacy degree does not change is assumed to be high. In another specific action, the probability that the information provision adequacy degree becomes high is higher as the time elapses more in some cases (time amplification exists).

Therefore, the selection unit 124 selects a content having a type on the basis of a temporal feature of a specific behavior, in addition to, for example, the length of the specific behavior estimated in the estimation unit 123, and thus adequate content according to an elapsed time from generation of the specific behavior can be provided.

For example, in a case of an specific action having the time attenuation, the selection unit 124 selects a content that can be checked in a short time, in a case of a specific behavior whose the temporal feature is constant or a specific behavior having time amplification, the selection unit 124 selects a content that needs a long time to be checked. The selection unit 124 can also select a content having a type in accordance with a time amplification/attenuation rate of a specific behavior.

The selection unit 124 can select a content according to information on a type or details of another content of which the terminal device 10 is notified. The acquisition unit 121 acquires information on the type or the details of another content of which the terminal device 10 is notified from, for example, the terminal device 10.

For example, the selection unit 124 can select a content whose probability of being selected by the user U is higher than that of another content of which the terminal device 10 is notified. The another content of which the terminal device 10 is notified may be a content provided by a device other than the information processing apparatus 100 or a content provided by the information processing apparatus 100.

2.2.5. Provision Unit

The provision unit 125 executes information provision to the user U on the basis of the estimated result of the estimation unit 123. For example, in a case where the probability of a counter terminal behavior of the user U is high, the provision unit 125 transmits a content to the terminal device 10 of the user U via the communication unit 101, so that it is possible to provide the content to the user U. Thereby, a push-based information provision can be executed on the user U of the terminal device 10 whose operation mode is set to the first mode.

The provision unit 125 can provide, to the user U, a content according to the estimated result of the estimation unit 123. For example, the provision unit 125 transmits, to the terminal device 10 of the user U, a content determined by the estimation unit 123 that the probability of a counter terminal behavior is the highest, and thus can provide the content to the user U.

The provision unit 125 transmits, to the terminal device 10 of the user U, for example, a content having a type or details according to a type (hereinafter, may be referred to as “behavior type”) of a counter terminal behavior whose probability is estimated to be high (or adequacy score is equal to or more than threshold) in the estimation unit 123, and thus the content can be provided to the user U. The provision unit 125 transmits, to the terminal device 10 of the user U, for example, a content having a type or details according to the probability degree (hereinafter, may be referred to as “probability degree”) of a counter terminal behavior estimated in the estimation unit 123, and thus the content can be provided to the user U.

The provision unit 125 can also execute information provision in a notification mode according to the estimated result of the estimation unit 123. In this case, the provision unit 125 can decide a notification mode in accordance with, for example, a behavior type and/or the probability degree, and can request (instruct) the terminal device 10 to execute information provision in this notification mode. This request includes, for example, a content being an information provision target and information on the notification mode. As described above, the notification mode includes modes such as a notification method, notification details, and notification means of the content.

The provision unit 125, for example, causes the terminal device 10 to emphasize and output a notification sound and a notification screen (for example, enlarge) to be able to select a notification method whose notification is noticeable, and causes the terminal device 10 to output a notification sound and a notification screen without emphasis thereof (for example, reduce) to be able to select a notification method whose notification is modest. The provision unit 125 causes the terminal device 10, for example, to repeatedly output a notification sound and a notification screen to be able to select a notification method whose notification is persistent.

The provision unit 125 can select, as the notification details, notification details that notify of, for example, only a title of a content, or can select notification details that notify of, for example, only a title and a summary.

The provision unit 125 selects one or more notification means among the speaker 12b, the vibration unit 12c, and a peripheral device of the user U in addition to, for example, the display of a content on the display 12a, and thus can execute a notification (notification that indicates fact that content is notified of) to the user U by using the selected notification means.

For example, the provision unit 125 can cause the speaker 12b to output a notification sound, the vibration unit 12c to output the vibration, a peripheral device of the user U to output information, etc. The provision unit 125 can execute, for example, by using an e-mail as notification means, a notification to the user U by using an e-mail, or can execute a notification by using lighting or blinking of a Light-Emitting Diode (LED: not illustrated) of the terminal device 10.

The provision unit 125 transmits, to the terminal device 10 of the user U, a content selected by the selection unit 124 in accordance with the length of a specific behavior of the user U estimated by the estimation unit 123 to be able to provide the content to the user U. Thereby, the provision unit 125 can provide, to the user U, for example, a content whose length is appropriate to an interruption to the user U.

In a case where the probability of a counter terminal behavior of the user U is high, the provision unit 125 can provide, to the user U, on the basis of the estimated result of the estimation unit 123, a content according to information on a type or details of another content that is notified of by the terminal device 10. In this case, the provision unit 125 can provide, to the user U, for example, a content that does not compete with another content or a content whose interest degree of the user U is higher than that of another content.

The provision unit 125 can provide, to the terminal device 10, information on a learning model stored in the model information storing unit 111. The provision unit 125 can provide, to the terminal device 10, information on an estimation model stored in the model information storing unit 111.

3. Processing Procedure of Information Processing System

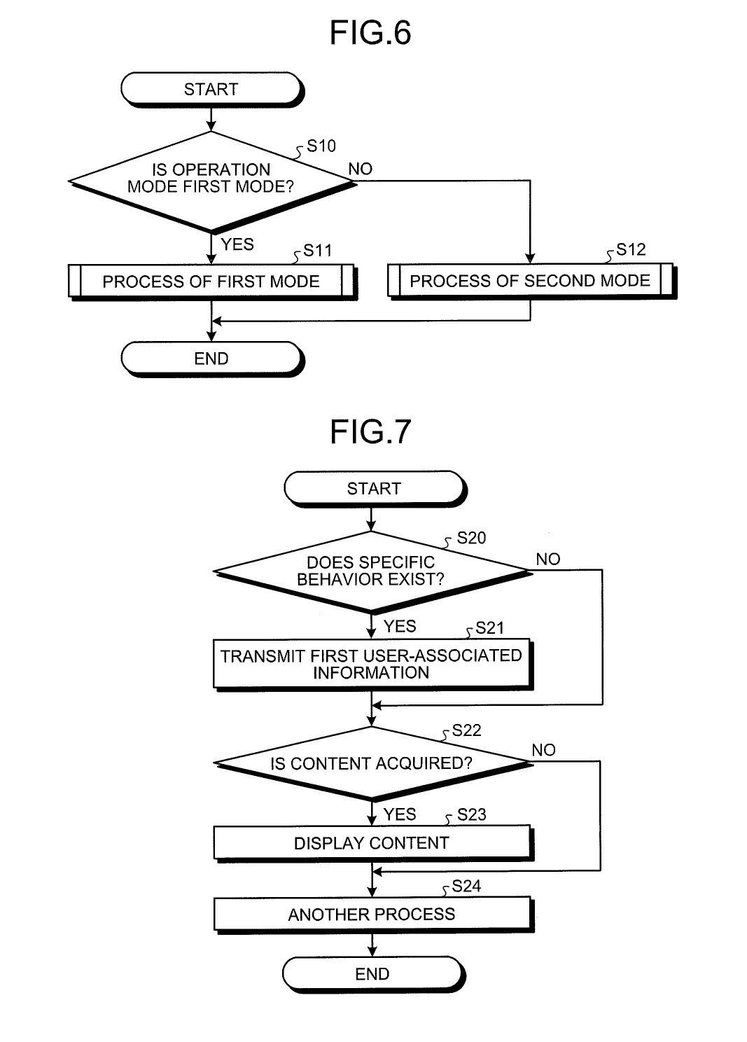

Next, a procedure of information process in the information processing system 1 will be explained. First, a procedure of information process in the terminal device 10 will be explained with reference to FIG. 6. FIG. 6 is a flowchart illustrating an information processing procedure of the terminal device 10, and these processes are repeatedly executed.

As illustrated in FIG. 6, the controller 16 of the terminal device 10 determines whether or not an operation mode of the terminal device 10 is the first mode on the basis of the mode information 32 stored in the storage unit 15 (Step S10).

When determining that the operation mode is the first mode (Step S10: Yes), the controller 16 executes a process of the first mode (Step S11). The process of Step S11 corresponds to processes of Steps S20 to S24 illustrated in FIG. 7, and is to be mentioned later.

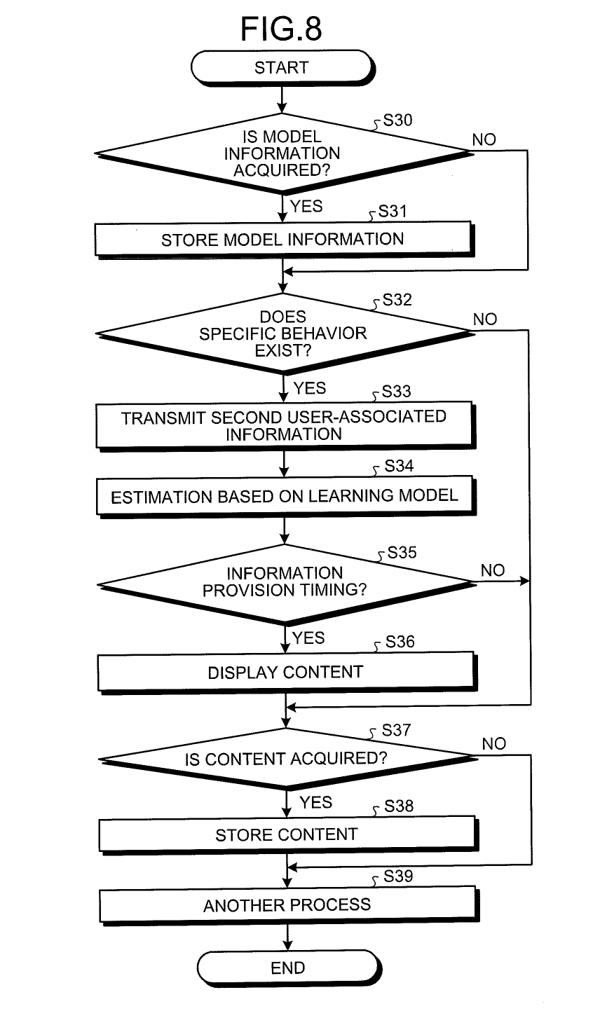

On the other hand, when determining that the operation mode is not the first mode (Step S10: No), the controller 16 executes a process of the second mode (Step S12). The process of Step S12 corresponds to processes of Steps S30 to S39 illustrated in FIG. 8, and is to be mentioned later. When the processes of Steps S11 and S12 are terminated, the controller 16 terminates the process illustrated in FIG. 6.

Next, the process of the first mode of Step S11 will be explained. FIG. 7 is a flowchart illustrating a processing procedure of the first mode illustrated in FIG. 6.

As illustrated in FIG. 7, when the process of the first mode is started, the controller 16 determines whether or not a behavior of the user U is a specific behavior (Step S20). When determining that the behavior of the user U is a specific behavior (Step S20: Yes), the controller 16 transmits user-associated information as first user-associated information (Step S21).

When determining that the behavior of the user U is not a specific behavior (Step S20: No), or when the process of Step S21 is terminated, the controller 16 determines whether or not a content is acquired from the information processing apparatus 100 (Step S22). When determining that the content is acquired (Step S22: Yes), the controller 16 causes the display 12a to display the acquired content (Step S23).

When determining that the content is not acquired (Step S22: No), or when the process of Step S23 is terminated, the controller 16 executes another process (Step S24), and terminates the process illustrated in FIG. 7. In the process of Step S24, for example, the controller 16 can determine whether or not the user U responds to (for example, clicks) a content displayed on the display 12a in Step S23, and thus can store, in the storage unit 15, the information that indicates the response of the user U to the content.

Next, the process of the second mode of Step S12 will be explained. FIG. 8 is a flowchart illustrating a processing procedure of the second mode illustrated in FIG. 6.

As illustrated in FIG. 8, when the process of the second mode is started, the controller 16 determines whether or not model information is acquired from the information processing apparatus 100 (Step S30). When determining that the model information is acquired (Step S30: Yes), the controller 16 stores the acquired model information in the storage unit 15 (Step S31).

When the process of Step S31 is terminated, or when determining that the model information is not acquired (Step S30: No), the controller 16 determines whether or not the behavior of the user U is a specific behavior (Step S32).

When determining that the behavior of the user U is a specific behavior (Step S32: Yes), the controller 16 transmits user-associated information as second user-associated information (Step S33). The controller 16 estimates, by using user-associated information, the probability of a behavior of the user U performed on the terminal device 10 by using a learning model included in the model information 31 stored in the storage unit 15 (Step S34).

The controller 16 determines whether or not it is an information provision timing on the basis of the estimated result of the probability of a behavior of the user U performed on the terminal device 10 (Step S35). In this process, for example, in a case where the probability of a behavior of the user U performed on the terminal device 10 is high (for example, equal to or more than threshold), the controller 16 determines that it is an information provision timing.

When determining that it is an information provision timing (Step S35: Yes), the controller 16 causes the display 12a to display a content stored in the storage unit 15 (Step S36). When determining that it is an information provision timing, the controller 16 may request a content from the information processing apparatus 100, and may cause the display 12a to display the content acquired in accordance with this request.

When the process of Step S36 is terminated, when determining that the behavior of the user U is not a specific behavior (Step S32: No), or when determining that it is not an information provision timing (Step S35: No), the controller 16 determines whether or not the content is acquired from the information processing apparatus 100 (Step S37).

When determining that the content is acquired (Step S37: Yes), the controller 16 stores the acquired content in the storage unit 15 (Step S38). When the process of Step S38 is terminated or when determining that the content is not acquired (Step S37: No), the controller 16 executes another process (Step S39) to terminate the process illustrated in FIG. 8. The process of Step S39 is similar to the process of Step S24 illustrated in FIG. 7.

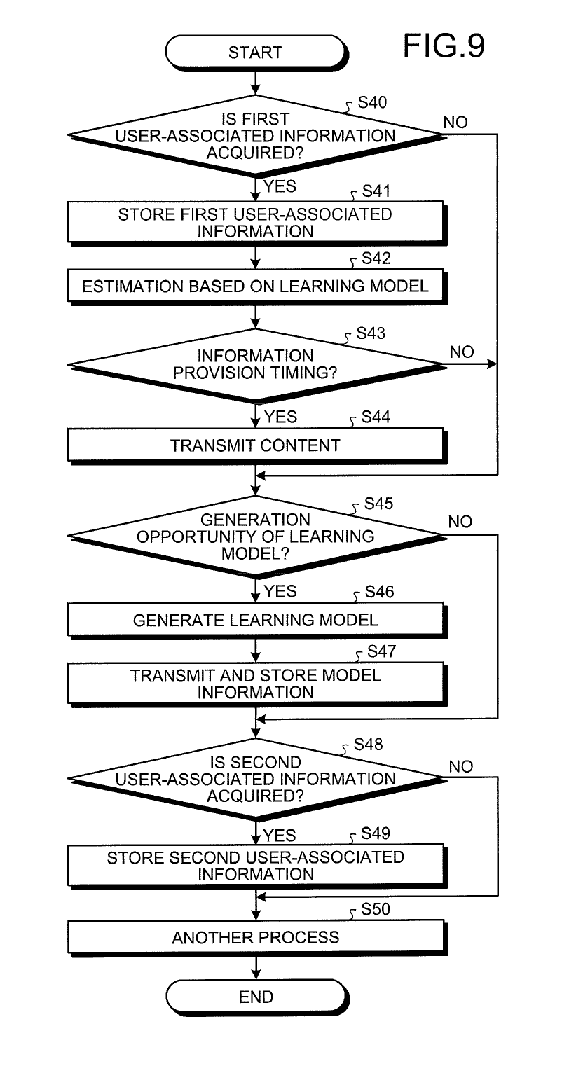

Next, an information processing procedure in the information processing apparatus 100 will be explained with reference to FIG. 9. FIG. 9 is a flowchart illustrating a processing procedure of the information processing apparatus 100, and the process is repeatedly executed.

As illustrated in FIG. 9, the controller 103 of the information processing apparatus 100 determines whether or not the first user-associated information is acquired form the terminal device 10 (Step S40). When determining that the first user-associated information is acquired (Step S40: Yes), the first user-associated information is stored in the storage unit 102 (Step S41).

The controller 103 executes an estimation, by using a learning model, by using the first user-associated information as input information (Step S42). In this process, the controller 103 estimates the probability of a behavior of the user U performed on the terminal device 10, from the learning model stored in the storage unit 102, by using, for example, the first user-associated information as input information.

Next, the controller 103 determines whether or not it is an information provision timing on the basis of the estimated result of the probability of a behavior of the user U performed on the terminal device 10 (Step S43). In this process, in a case where the probability of a behavior of the user U performed on the terminal device 10 is high (for example, equal to or more than threshold), the controller 103 determines that it is an information provision timing. When determining that it is an information provision timing (Step S43: Yes), the controller 103 transmits the content to the terminal device 10 of the user U corresponding to a notification target (Step S44).

When the process of Step S44 is terminated, when determining that the first user-associated information is not acquired (Step S40: No), or when determining that it is not an information provision timing (Step S43: No), the controller 103 shifts the process to Step S45.

In Step S45, the controller 103 determines whether or not it is a generation opportunity of a learning model. The controller 103 can generate a generation opportunity of a learning model at each time of storing of a predetermined number of pieces of new user-associated information in the storage unit 102 or in each predetermined period.

When determining that it is a generation opportunity of a learning model (Step S45: Yes), the controller 103 generates or updates the learning model by using the user-associated information stored in the storage unit 102 (Step S46), and transmits to the terminal device 10 the model information including information on the generated or updated learning model, or stores in the storage unit 102 the generated or updated model information (Step S47).

When the process of Step S47 is terminated, or when determining that it is not a generation opportunity of a learning model (Step S45: No), the controller 103 determines whether or not the second user-associated information is acquired from the terminal device 10 (Step S48). When determining that the second user-associated information is acquired (Step S48: Yes), the second user-associated information is stored in the storage unit 102 (Step S49).

When the process of Step S49 is terminated, or when determining that the second user-associated information is not acquired (Step S48: No), the controller 103 executes another process (Step S50) to terminate the process illustrated in FIG. 9. In the process of Step S50, the controller 103 can acquire information on a social environment of the user U and information on a physical environment of the user U from, for example, an external device.

4. Modification

In the aforementioned embodiment, the example in which the terminal device 10 determines a specific behavior of the user U has been explained, the controller 103 of the information processing apparatus 100 may also detect a specific behavior of the user U on the basis of information detected by the detection unit 14 and the like of the terminal device 10 and information detected by the sensor device 50. Moreover, the sensor device 50 may detect, similarly to the terminal device 10, a specific behavior of the user U, and may notify the terminal device 10 and the information processing apparatus 100 of this detection result.

In the aforementioned embodiment, the example in which one user U has one terminal device 10 has been explained, one user U may have the plurality of terminal devices 10. In this case, the controller 103 of the information processing apparatus 100 may provide a content on the basis the pieces of user-associated information transmitted from the plurality of terminal devices 10, respectively.

The terminal device 10 may determine whether or not the user U performs a specific behavior on the basis of a plurality of pieces of information acquired by a plurality of devices including this terminal device 10. In other words, the terminal device 10 may determine whether or not the user U performs a specific behavior on the basis of the detection result acquired by multi devices.

The generation unit 122 of the information processing apparatus 100 may generate two or more learning models on the basis of user-associated information on the plurality of terminal devices 10₁ to 10ₙ. For example, the generation unit 122 may generate a learning model for each of the groups of the divided plurality of terminal devices 10 in a predetermined reference. For example, the generation unit 122 may generate a learning model for each group divided on the basis of age or gender. The generation unit 122 may also generate a learning model for each user U.

In the aforementioned embodiment, the example in which the controller 103 of the information processing apparatus 100 executes generation of a learning model has been explained. However, the generation of the learning model may be executed by the controller 16 of the terminal device 10. The controller 16 may also update, after acquisition of a learning model generated by the controller 103, the learning model on the basis of user-associated information on the own device.

In the aforementioned embodiment, the example in which “1” and “−1” are selectively set for “y” in the learning model has been explained, however is not limited thereto. For example, “1” and “0” may be selectively set for “y”. In a case of a learning model generated by selectively setting a positive value (for example, “1”) and a negative value (for example, “−1”) for “y”, the estimation unit 123 and the timing determining unit 44 may execute computation using a sign function for output information (“y”) of this learning model. In this case, for example, when the output of the sign function is “1”, the estimation unit 123 and the timing determining unit 44 may determine that the probability of a behavior of the user U performed on the terminal device 10 is high, when the output of the sign function is “−1”, the estimation unit 123 and the timing determining unit 44 may determine that the probability of a behavior of the user U performed on the terminal device 10 is low.

5. Hardware Configuration

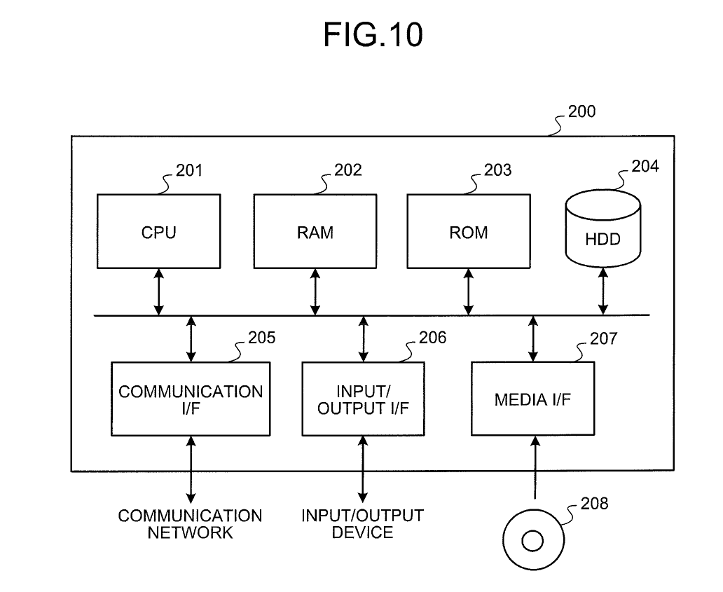

Each of the terminal device 10 and the information processing apparatus 100 according to the aforementioned embodiment is realized by execution of a program by a computer 200 having such a configuration illustrated in, for example, FIG. 10.

FIG. 10 is a diagram illustrating a hardware configuration example of a computer that executes a program. The computer 200 includes a Central Processing Unit (CPU) 201, a Random Access Memory (RAM) 202, a Read Only Memory (ROM) 203, a Hard Disk Drive (HDD) 204, a communication interface (communication I/F) 205, an input/output interface (input/output I/F) 206, and a media interface (media I/F) 207.

The CPU 201 operates on the basis of a program stored in the ROM 203 or the HDD 204 to control each unit. The ROM 203 stores a boot program to be executed by the CPU 201 at the start-up of the computer 200, a program depending on the hardware of the computer 200, etc.

The HDD 204 stores data and the like to be used by a program executed by the CPU 201. The communication I/F 205 corresponds to each of the communication units 11 and 101, receives data from another device via the network 2, transmits the data to the CPU 201, and transmits the data generated by the CPU 201 to another device via the network 2.

The CPU 201 controls, via the input/output interface 206, output devices such as a display and a printer; and input devices such as a keyboard and a mouse. The CPU 201 acquires, via the input/output interface 206, data from the input devices. The CPU 201 outputs, via the input/output interface 206, generated data to the output devices.

The media interface 207 reads a program or data stored in a storage medium 208, and provides the program or the data to the CPU 201 via the RAM 202. The CPU 201 loads this program on the RAM 202 from the storage medium 208 via the media interface 207, and executes the loaded program. The storage medium 208 is an optical storage medium such as a Digital Versatile Disc (DVD) or a Phase change rewritable Disk (PD); a magneto-optical storage medium such as a Magneto-Optical disk (MO); a tape medium; a magnetic medium; a semiconductor memory; or the like.

In a case where the computer 200 functions as the terminal device 10, the CPU 201 of the computer 200 executes a program loaded on the RAM 202, and thereby realizes a function of each of the state determining unit 41, the acquisition unit 42, the transmission unit 43, the timing determining unit 44, and the process unit 45 illustrated in FIG. 3. In a case where the computer 200 functions as the information processing apparatus 100, the CPU 201 of the computer 200 executes a program loaded on the RAM 202, and thereby realizes a function of each of the acquisition unit 121, the generation unit 122, the estimation unit 123, the selection unit 124, and the provision unit 125 illustrated in FIG. 5.

The CPU 201 of the computer 200 reads and executes the aforementioned program from the storage medium 208. However, as another example, the CPU 201 may acquire the aforementioned program from another device via the network 2.

The HDD 204 corresponds to each of the storage units 15 and 102, and stores data being similar to the corresponding storage unit 15 or 102. A semiconductor memory element such as a Random Access Memory (RAM) or a flash memory; or a storage device such as an optical disk may be used instead of the HDD 204.

6. Effects

The information processing apparatus 100 according to the aforementioned embodiment includes the acquisition unit 121 and the generation unit 122. The acquisition unit 121 acquires, when the user U performs one of specific behaviors having a plurality of types, information on the behavior (counter terminal behavior) of the user U performed on the terminal device 10 and information on context associated with the user. The generation unit 122 executes machine learning by using, as feature amounts, information on each of the specific behaviors and the information on the context, to generate a learning model of the behavior of the user U performed on the terminal device 10. By employing this learning model, an appropriate timing in which the probability that the user U pays attention to provided information is high can be estimated.

The information processing apparatus 100 includes the estimation unit 123. The estimation unit 123 estimates, when the user U newly performs one of the specific behaviors, a probability of a behavior of the user U for the terminal device from the learning model by using, as input information, information on the newly-performed specific behavior and the information on the context associated with the user U. Thereby, an appropriate timing in which the probability that the user U pays attention to provided information is high can be estimated.

The information processing apparatus 100 includes the provision unit 125. The provision unit 125 executes information provision to the user based on an estimated result of the estimation unit 123. Thereby, information provision can be executed on the user U at an appropriate timing in which the probability that the user U pays attention to provided information is high.

The provision unit 125 executes information provision of providing, to the terminal device 10, content according to the estimated result of the estimation unit 123. Thereby, adequate content according to the estimated result of the estimation unit 123 can be provided to the user U.

The acquisition unit 121 acquires information on a behavior of the user U for the content provided to the terminal device 10 as the information on the behavior of the user U performed on the terminal device 10. The behavior of the user U for the content is to be performed at a timing when the user U pays attention thereto, and thereby an appropriate timing can be estimated, in which the probability that the user U pays attention to provided information is high.

The acquisition unit 121 acquires information on a behavior of the user U for the content provided to the terminal device 10 as the information on the context associated with the user U. Thereby, content according to the estimated result of the estimation unit 123 can be provided to the user U.

The provision unit 125 executes the information provision in a notification mode according to the estimated result of the estimation unit 123. Thereby, information provision to the user U can be executed in a notification mode according to the estimated result. Therefore, for example, information provision to the user U can be executed in a notification mode that differs in accordance with a behavior type and the probability degree, and thereby appropriate information provision can be executed on the user U.

The context associated with the user includes at least one of an attribute of the user U, a current position of the user U, current time, a physical environment in which the user U is put, a social environment in which the user U is put, a motion state of the user U, and emotion of the user U. Thereby, for example, a learning model of a behavior of the user U performed on the terminal device 10 can be generated in consideration of at least one of the attribute, the current position, the current time, the physical environment, the social environment, the motion state, and the emotion.

The provision unit 125 executes information provision of providing, to the terminal device 10, a content according to information on a type or details of another content of which the terminal device 10 is notified based on the estimated result of the estimation unit 123. The content not competing with another content can be provided to the user U or the content whose interest degree of the user U is higher than that of another content can be provided to the user U, and thus the content can be provided, which can cause the probability of being selected by the user to increase prior to another content.

The generation unit 122 executes the machine learning by using, as feature amounts, the information on each of the specific behaviors and the information on the context, to generate an estimation model of estimating a length of the specific behavior. By employing the estimation model, the length of a specific behavior of the user U can be estimated.

The estimation unit 123 estimates, when the user newly performs one of the specific behaviors, the length of the specific behavior from the estimation model by using, as input information, information on the newly-performed specific behavior and the information on the context associated with the user U. Thereby, for example, an information provision timing and a content according to the estimated length of the estimation model can be selected.

The information processing apparatus 100 further includes the selection unit 124. The selection unit 124 selects a content having a type according to the length of the specific behavior estimated by the estimation unit 123. The provision unit 125 executes information notification that provides the content selected by the selection unit 124 to a user Uniform Resource Locator (URL). Thereby, an adequate content according to the length of a specific behavior of the user U can be provided to the user U.

The selection unit 124 selects a content having a type according to the length of the specific behavior estimated by the estimation unit 123 and a temporal feature of the specific behavior. Thereby, adequate content according to an elapsed time from the generation of a specific behavior of the user U can be provided.

The specific behavior of the user U is detected by at least one of the terminal device 10 and the sensor device 50 (one example of device other than terminal device 10).

The information processing system 1 according to the embodiment includes the terminal device 10 in addition to the information processing apparatus 100. The provision unit 125 of the information processing apparatus 100 transmits, to the terminal device 10, information on the learning model generated by the generation unit 122. The acquisition unit 42 acquires information on the learning model and stores this information in the storage unit 15. The timing determining unit 44 estimates, when the user newly performs one of the specific behaviors, a probability of a counter terminal behavior (one example of behavior of the user U for the terminal device 10) from the learning model by using, as input information, information on the newly-performed specific behavior and the information on the context associated with the user U. Thereby, the estimated result of the probability of a counter terminal behavior can be acquired via the network 2 without transmitting the user-associated information.

The aforementioned information processing apparatus 100 may be realized by a plurality of server computers, or some of the functions may be realized by calling an external platform and the like by using an Application Programming Interface (API), network computing, etc. Thus, the configuration of the information processing apparatus 100 may be flexibly changed.

The aforementioned “section, module, unit” may be replaced by “means”, “circuit”, etc. For example, a generation unit may be replaced by a generation means or a generation circuit.

According to an aspect of the embodiment, an information processing apparatus, an information processing system, an information processing method, and a computer-readable recording medium can be provided, which can detect a timing more appropriate to an interruption to a user.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus comprising:
an acquisition unit that acquires, when a user performs one of specific behaviors respectively having a plurality of types, information on a behavior of the user performed on a terminal device and information on context associated with the user; and
a generation unit that executes machine learning by using, as feature amounts, information on each of the specific behaviors and the information on the context, to generate a learning model of the behavior of the user performed on the terminal device.

2. The information processing apparatus according to claim 1, further comprising an estimation unit that estimates, when the user newly performs one of the specific behaviors, a probability of a behavior of the user for the terminal device from the learning model by using, as input information, information on the newly-performed specific behavior and the information on context associated with the user.

3. The information processing apparatus according to claim 2, further comprising a provision unit that executes information provision to the user based on an estimated result of the estimation unit.

4. The information processing apparatus according to claim 3, wherein the provision unit executes the information provision by providing, to the terminal device, a content according to the estimated result of the estimation unit.

5. The information processing apparatus according to claim 4, wherein the acquisition unit acquires information on a behavior of the user for the content provided to the terminal device as the information on the behavior of the user performed on the terminal device.

6. The information processing apparatus according to claim 4, wherein the acquisition unit acquires information on a behavior of the user for the content provided to the terminal device as the information on the context associated with the user.

7. The information processing apparatus according to claim 3, wherein the provision unit executes the information provision in a notification mode according to the estimated result of the estimation unit.

8. The information processing apparatus according to claim 3, wherein the provision unit executes the information provision by providing, to the terminal device, a content according to information on a type or details of another content of which the terminal device is notified from other than the information processing apparatus based on the estimated result of the estimation unit.

9. The information processing apparatus according to claim 1, wherein the context associated with the user includes at least one of an attribute of the user, a current position of the user, current time, a physical environment in which the user is put, a social environment in which the user is put, a motion state of the user, and emotion of the user.

10. The information processing apparatus according to claim 1, wherein the generation unit executes the machine learning by using, as feature amounts, the information on each of the specific behaviors and the information on the context, to generate an estimation model of estimating a length of the specific behavior.

11. The information processing apparatus according to claim 10, further comprising an estimation unit that estimates, when the user newly performs one of the specific behaviors, the length of the specific behavior from the estimation model by using, as input information, information on the newly-performed specific behavior and the information on the context associated with the user.

12. The information processing apparatus according to claim 11, further comprising:
a selection unit that selects a content having a type according to the length of the specific behavior estimated by the estimation unit; and
a provision unit that executes information notification of providing, to the user, the content selected by the selection unit.

13. The information processing apparatus according to claim 12, wherein the selection unit selects a content having a type according to the length of the specific behavior estimated by the estimation unit and a temporal feature of the specific behavior.

14. An information processing system including the information processing apparatus according to claim 1 and the terminal device,
the information processing apparatus transmitting, to the terminal device, information on the learning model generated by the generation unit, and
the terminal device comprising:
an acquisition unit that acquires information on the learning model; and
an estimation unit that estimates, when the user newly performs one of the specific behaviors, a probability of a behavior of the user for the terminal device from the learning model by using, as input information, information on the newly-performed specific behavior and the information on the context associated with the user.

15. An information processing method executed by a computer, the method comprising:
acquiring, when a user performs one of specific behaviors respectively having a plurality of types, information on a behavior of the user performed on a terminal device and information on context associated with the user; and
executing machine learning by using, as feature amounts, information on each of the specific behaviors and the information on the context to generate a learning model of the behavior of the user performed on the terminal device.

16. A non-transitory computer-readable recording medium having stored therein an information processing program that causes a computer to execute a process, the process comprising:
acquiring, when a user performs one of specific behaviors respectively having a plurality of types, information on a behavior of the user performed on a terminal device and information on context associated with the user; and
executing machine learning by using, as feature amounts, information on each of the specific behaviors and the information on the context to generate a learning model of the behavior of the user performed on the terminal device.

17. A non-transitory computer-readable recording medium having stored therein an information processing program that causes a computer to execute a process, the process comprising:
acquiring information on a learning model in which information on each specific behavior of a user and information on context associated with the user are set as feature amounts; and
estimating, when the user newly performs one of the specific behaviors, a probability of a behavior of the user for the terminal device from the learning model by using, as input information, information on the newly-performed specific behavior and the information on the context associated with the user.
